(19) United States
(12) Patent Application Publication
(10) Pub. No.: US 2009/0083939 A1
(43) Pub. Date: Apr. 2, 2009

(54) DAMPER DEVICE FOR RETARDING PIVOTAL ADVANCEMENT OF A HINGED WALL PIECE TOWARDS A HINGING WALL PIECE

(76) Inventor: Chung-Hsin WU, Tainan Hsien (TW)

Correspondence Address: OSTROLENK FABER GERB & SOFFEN, 1180 AVENUE OF THE AMERICAS, NEW YORK, NY, 100368403, US

(21) Appl. No.: 11/866,031

(22) Filed: Oct. 2, 2007

(51) Int. Cl. E05F 5/02

(52) U.S. Cl. 16/85

(57) ABSTRACT

A damper device for retarding pivotal advancement of a hinged wall piece towards a hinging wall piece includes a tubular housing adapted to be mounted on one of the hinged and hinging wall pieces, a resisting seat with a resisting end, a position shifting mechanism disposed to couple the resisting seat to the housing such that the resisting seat is retainingly shiftable relative to the housing to permit movement of the resisting end, and a damper unit which has impacted and abutment ends and which is compressible such that, upon being pushed by an impact force, the impacted end is thrust towards the abutment end so as to acquire a damping force to counteract the impact force. The abutment end is engaged and moved with the resisting end for adjustment of the damping force.

### BACKGROUND OF THE INVENTION

1. Field of the Invention

This invention relates to a damper device, more particularly to a damper device for retarding pivotal advancement of a hinged wall piece towards a hinging wall piece.

2. Description of the Related Art

A conventional damper built-in door hinge, which is provided for pivoting a door to a framework, generally has a mechanical door closing mechanism for advancing a hinged door towards a hinging framework, and has a damping mechanism for retarding the turning advancement of the door to reduce an impact upon closing of the door. Such a damper built-in door hinge is complicated and costly. Moreover, the damping force of the damping mechanism is not adjustable to suit different mounting conditions.

### SUMMARY OF THE INVENTION

The object of the present invention is to provide a damper device which can be used with a door hinge, which has a simple structure so as to be easily assembled to a hinged door assembly, and which provides an adjustable damping force to suit different mounting conditions.

According to this invention, the damper device includes a tubular housing which has front and rear ends opposite to each other, and an intermediate segment interposed therebetween. The intermediate segment has an accommodation chamber extending along an adjusting axis. The tubular housing is adapted to be mounted on one of hinged and hinging wall pieces with the adjusting axis transverse to a hinged axis of the hinged wall piece. A resisting seat is insertable into the accommodation chamber so as to be disposed proximate to the rear end, and has a resisting end distal from the rear end. A position shifting mechanism is disposed to couple the resisting seat to the tubular housing such that the resisting seat is retainingly shiftable relative to the intermediate segment between a front position, where the resisting is closer to the front end, and a rear position, where the resisting end is remote from the front end. A damper unit has impacted and abutment ends, and is disposed in the accommodation chamber such that the impacted end extends outwardly of the front end. The damper unit is configured to be compressible such that, upon being pushed by an impact force generated as a result of the pivotal advancement of the hinged wall piece, the impacted end is thrust towards the abutment end so as to acquire a damping force to counteract the impact force, thereby retarding the pivotal advancement. The abutment end is disposed to engage the resisting end such that, when the resisting end is shifted between the front and rear positions, the impacted end is moved relative to the front end so as to adjust a distance therebetween.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of the first preferred embodiment of a damper device according to this invention;

FIG. 2 is a fragmentary perspective view of the first preferred embodiment, showing a resisting seat in a rear position;

FIG. 3 is a perspective view of the first preferred embodiment when assembled on a hinging framework;

FIG. 4 is a fragmentary perspective view of the first preferred embodiment, showing the resisting seat in a front position;

FIG. 5 is a perspective view of the first preferred embodiment when assembled on a hinged door;

FIG. 6, is a perspective views of the second preferred embodiment of the damper device according to this invention; and

FIGS. 7 and 8 are perspective views of modified forms of the second preferred embodiment.

### DETAILED DESCRIPTION OF THE PREFERRED EMBODIMENTS

Before the present invention is described in greater detail, it should be noted that same reference numerals have been used to denote like elements throughout the specification.

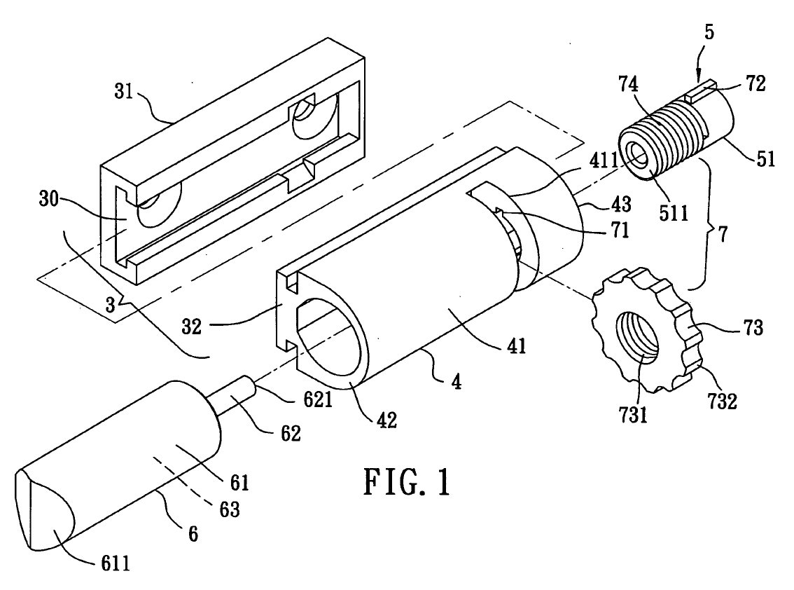

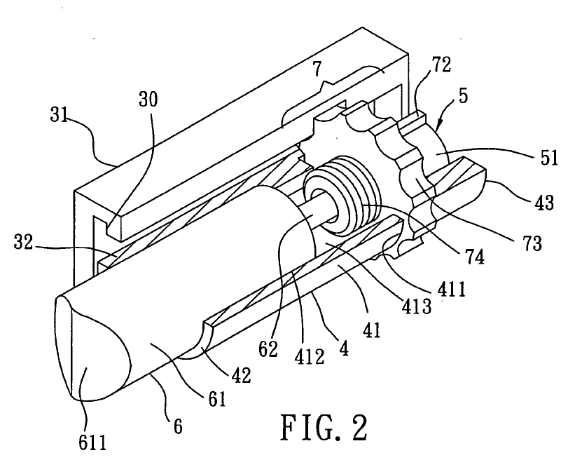

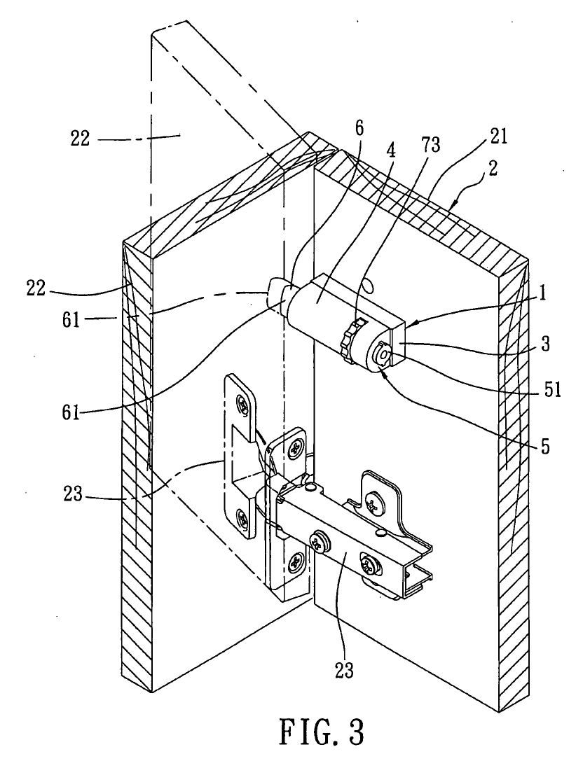

Referring to FIG. 3, the first preferred embodiment of a damper device 1 according to the present invention is adapted to be assembled to a door assembly 2. The door assembly 2 includes a framework 21 serving as a hinging wall piece, and a door 22 serving as a hinged wall piece which is hinged to the framework 21 by a hinge 23 that is turnable relative to the framework 21 about a hinged axis. The hinge 23 has a door closing mechanism for turning the door 22 towards the framework 21 after the door 22 is pushed open. With reference to FIGS. 1 and 2, the damper device 1 is shown to comprise a tubular housing 4, a mounting unit 3, a resisting and shifting unit 5, and a damper unit 6.

The tubular housing 4 has front and rear ends 42, 43 which are opposite to each other along an adjusting axis, and an intermediate segment 41 which is interposed between the front and rear ends 42, 43, and which has an inner surrounding wall surface 412 defining an accommodation chamber 413 that extends along the adjusting axis to the front and rear ends 42, 43. The inner surrounding wall surface 412 has an access slot 411 which extends angularly about the adjusting axis and radially through the intermediate segment 41.

In this embodiment, the mounting unit 3 includes a mounting seat 31 which is adapted to be fixed to the framework 21 and which has a mortise 30, and a tenon 32 which is integrally formed with the tubular housing 4 and which is joined to the mortise 30. Thus, the tubular housing 4 can be secured to the framework 21 with the adjusting axis transverse to the hinged axis of the door 22.

The resisting and shifting unit 5 includes a resisting seat 51 and a position shifting mechanism 7. The resisting seat 51 is insertable into the accommodation chamber 413 from the rear end 43 so as to be disposed proximate to the rear end 43, and has a resisting end 511 distal from the rear end 43.

The position shifting mechanism 7 includes a keyway 71 which is disposed in the inner surrounding wall surface 412 of the tubular housing 4 and which extends along the adjusting axis, a key 72 which is disposed on the resisting seat 51 and which is engaged in the keyway 71 so as to guide the resisting seat 51 to move relative to the intermediate segment 41 only along the adjusting axis, an actuating nut 73 which is disposed in the accommodation chamber 413 through the access slot 41 to be rotatable about the adjusting axis and which has an internal thread portion 731, and an external thread portion 74 which is disposed on the resisting seat 51 adjacent to the resisting end 511, which surrounds the adjusting axis, and which is configured to mate with the internal thread portion 731 such that the actuating nut 73 is rotatable about the adjusting axis so as to result in shifting of the resisting seat 51 along the adjusting axis between a front position, where the resisting end 511 is closer to the front end 42, and a rear position, where the resisting end 511 is remote from the front end 42. The actuating nut 73 has an outer surrounding surface 732 which is radially opposite to the internal thread portion 731 and which is serrated to facilitate operation.

In this embodiment, the damper unit 6 is disposed in the accommodation chamber 413, and includes a piston rod 62 with an abutment end 621 that engages the resisting end 511, and a cylinder 61 with an impacted end 611 opposite to the abutment end 621 and extending forwardly of the front end 42, and a working fluid 63 contained in the cylinder 61 such that, when the impacted end 611 is thrust towards the abutment end 621, the working fluid 63 is compressed by the piston rod 62, thereby acquiring a damping force. Specifically, the damper unit 6 may be a hydraulic cylinder, a pneumatic cylinder, or a combination of hydraulic and pneumatic cylinder.

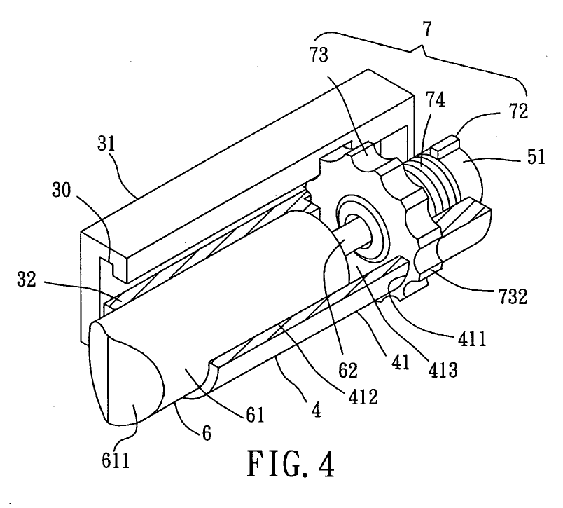

In assembly, the mounting seat 31 is first secured onto the framework 21, and the tenon 32 is then joined to the mortise 30 so as to retain the tubular housing 4 on the mounting seat 31. Subsequently, depending on the position where an impact force is desired to be generated by the turning advancement of the door 22 toward the framework 21 and to be applied to the impacted end 611, the position of the impacted end 611 relative to the front end 42 is adjusted by turning the actuating nut 73 to shift the resisting end 511 between the front and rear positions, as respectively shown in FIGS. 4 and 2. Thus, the distance between the impact end 611 and the front end 42 is adjustable.

During the automatic turning advancement of the door 22 via the hinge 23, the door 22 will push the impacted end 611 with the impact force, so that the impact end 611 is thrust towards the abutment end 621 and acquires a damping force to counteract the impact force, thereby retarding the pivotal advancement of the door 22. In this state, a restoring force is accumulated in the damper unit 6. The restoring force will urge the impacted end 611 away from the abutment end 621 when the door 22 is pushed open and turned away from the framework 21.

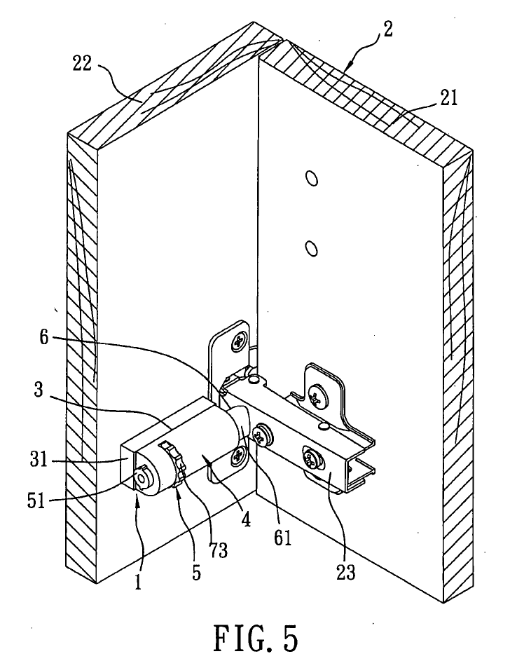

Alternatively, the arrangement of the cylinder 61 and the piston rod 62 in the damper unit 6 can be reversed. Specifically, the cylinder 61 is disposed to engage the resisting seat 51, and the piston rod 62 extends outwardly of the front end 42 to be thrust by the door 22. Additionally, referring to FIG. 5, the damper device 1 of this embodiment may also be mounted on the door 22 to permit the cylinder 61 of the damper unit 6 to be pushed by a housing of the hinge 23.

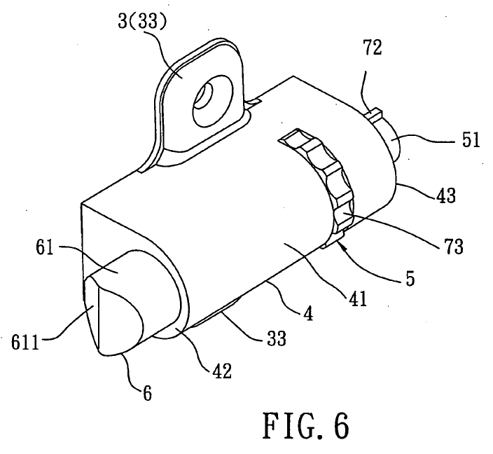

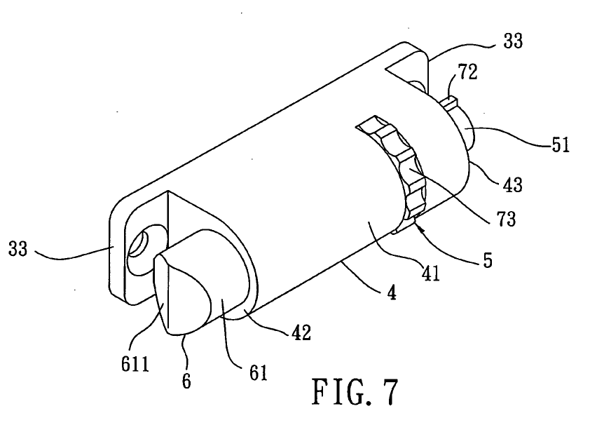

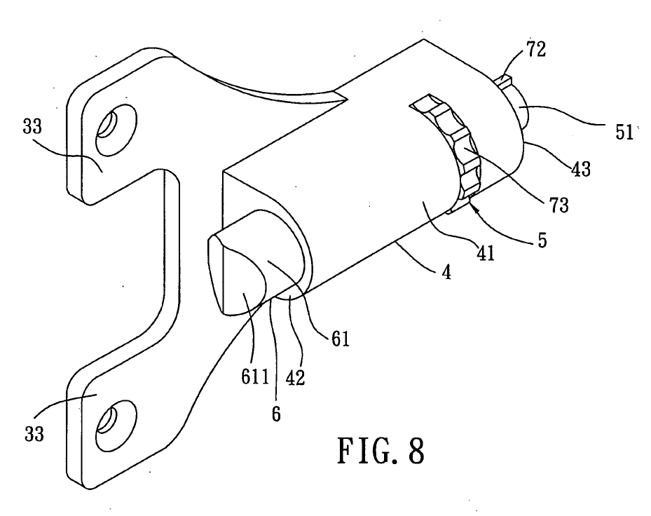

Referring to FIGS. 6 to 8, the second preferred embodiment of a damper device 1 according to this invention is shown to be similar to the first embodiment in construction, except that the mounting unit 3 includes a pair of lugs 33 which are integrally formed on the intermediate segment 41 of the tubular housing 4. In FIG. 6, the lugs 33 are formed diametrically opposite to each other. In FIG. 7, the lugs 33 are formed to extend respectively from the front and rear ends 42, 43 of the tubular housing 4. In FIG. 8, the lugs 33 are formed to extend forwardly of the front end 42 of the tubular housing 4. It is noted that the number and positions of the lugs 33 described above are for purposes of illustration only and are not intended to limiting the scope of this invention.

As illustrated, the damper device 1 of this invention can be used with a conventional door hinge without the need to replace the entire door hinge. In addition, the damper device 1 of this invention can be assembled to door or framework in an easy and convenient manner. Moreover, in order to acquire a desired damping force to counteract the impact force generated upon the pivotal advancement of the door, the damper unit 6 can be adjusted according to actual mounting conditions, e.g., the turning force of the door towards the framework, the position of the tubular housing 4, etc.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A damper device for retarding pivotal advancement of a hinged wall piece towards a hinging wall piece about a hinged axis, said damper device comprising:
a tubular housing which has front and rear ends that are opposite to each other along an adjusting axis, and an intermediate segment that is interposed between said front and rear ends, and that has an accommodation chamber extending along the adjusting axis to said front and rear ends, and which is adapted to be mounted on one of the hinged and hinging wall pieces with the adjusting axis transverse to the hinged axis;
a resisting seat which is insertable into said accommodation chamber so as to be disposed proximate to said rear end, and which has a resisting end distal from said rear end;
a position shifting mechanism disposed to couple said resisting seat to said tubular housing such that said resisting seat is retainingly shiftable relative to said intermediate segment between a front position, where said resisting end is closer to the front end, and a rear position, where said resisting end is remote from said front end; and
a damper unit which has impacted and abutment ends opposite to each other, and which is disposed in said accommodation chamber such that said impacted end extends outwardly of said front end, said damper unit being configured to be compressible such that, upon being pushed by an impact force generated as a result of the pivotal advancement of the hinged wall piece, said impacted end is thrust towards said abutment end so as to acquire a damping force to counteract the impact force, thereby retarding the pivotal advancement of the hinged wall piece, said abutment end being disposed to engage said resisting end such that, when said resisting end is shifted between the front and rear positions, said impacted end is moved relative to said front end so as to adjust a distance therebetween.

2. The damper device according to claim 1, wherein said intermediate segment of said tubular housing has an inner surrounding wall surface that defines said accommodation chamber,
said position shifting mechanism including
a keyway which is disposed in said inner surrounding wall surface and which extends along the adjusting axis,
a key which is disposed on said resisting seat and which is engaged in said keyway so as to guide said resisting seat to move relative to said intermediate segment only along the adjusting axis,
an actuating nut which is disposed to be rotatable about the adjusting axis and which has an internal thread portion, and
an external thread portion which is disposed on said resisting seat adjacent to said resisting end, which surrounds the adjusting axis and, and which is configured to mate with said internal thread portion such that rotation of said actuating nut results in shifting of said resisting seat along the adjusting axis.

3. The damper device according to claim 2, wherein said inner surrounding wall surface has an access slot which extends angularly about the adjusting axis and radially through said intermediate segment so as to permit said actuating nut to access said accommodation chamber and to be rotatable about the adjusting axis, said actuating nut having an outer surrounding surface which is radially opposite to said internal thread portion and which is serrated to facilitate operation.

4. The damper device according to claim 1, wherein said damper unit includes a piston rod with said abutment end, and a cylinder with said impacted end, and a working fluid contained in said cylinder such that, when said impacted end is thrust towards said abutment end, said working fluid is compressed by said piston rod, thereby acquiring the damping force.

5. The damper device according to claim 1, further comprising a mounting unit which is disposed to secure said tubular housing to said one of the hinged and hinging wall pieces.

6. The damper device according to claim 5, wherein said mounting unit includes a mortise which is adapted to be fixed to said one of the hinged and hinging wall pieces, and a tenon which is integrally formed with said tubular housing, and which is joined to said mortise.

7. The damper device according to claim 6, wherein said mounting unit includes a pair of lugs which are integrally formed with said tubular housing.
